(19) United States
(12) Patent Application Publication
(10) Pub. No.: US 2019/0141984 A1
(43) Pub. Date: May 16, 2019

(54) HUNTING BLIND SYSTEM AND METHOD OF USE

(71) Applicant: Aaron Loy Gilbreath, Arlington, TX (US)

(72) Inventor: Aaron Loy Gilbreath, Arlington, TX (US)

(21) Appl. No.: 16/189,544

(22) Filed: Nov. 13, 2018

Related U.S. Application Data
(60) Provisional application No. 62/585,282, filed on Nov. 13, 2017.

(51) Int. Cl. A01M 31/02

(52) U.S. Cl. CPC A01M 31/025; E04H 15/001

(57) ABSTRACT

A hunting blind system includes a rigid body forming an interior area, the rigid body having a front wall with a door positioned therein; a rigid roof secured to a top of the rigid body, the rigid roof having an exterior surface having a first color; and an interior surface facing the interior area and having a second color; the second color blocks sunlight.

### BACKGROUND

### 1. Field of the Invention

The present invention relates generally to hunting blind systems, and more specifically, to a hunting blind system with an improved aerodynamic design, seamless construction, and sun light blockage.

### 2. Description of Related Art

Hunting blind systems are well known in the art and are effective means to conceal a hunter. For example, FIG. 1 depicts a conventional hunting blind system 101 having a body 103 with one or more windows 105 and a door 107, the body mounted on a platform 109 with a stand 111 and a ladder 113. During use, the user remains inside body 103 and waits for wildlife, wherein the user can shoot through door 107 or window 105.

One of the problems commonly associated with system 101 is sun light entrance into the interior of the blind, thereby making visibility limited by creating shadows.

Accordingly, although great strides have been made in the area of hunting blind systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a common hunting blind system;

FIG. 2 is an oblique view of hunting blind system in accordance with a preferred embodiment of the present application;

FIG. 3 is a front view of the hunting blind system of FIG. 2;

FIG. 4 is a side view of the hunting blind system of FIG. 2;

FIG. 5 is a partial interior view of the hunting blind system of FIG. 2; and

FIG. 6 is a front view of an alternative embodiment of a hunting blind system in accordance with the present application.

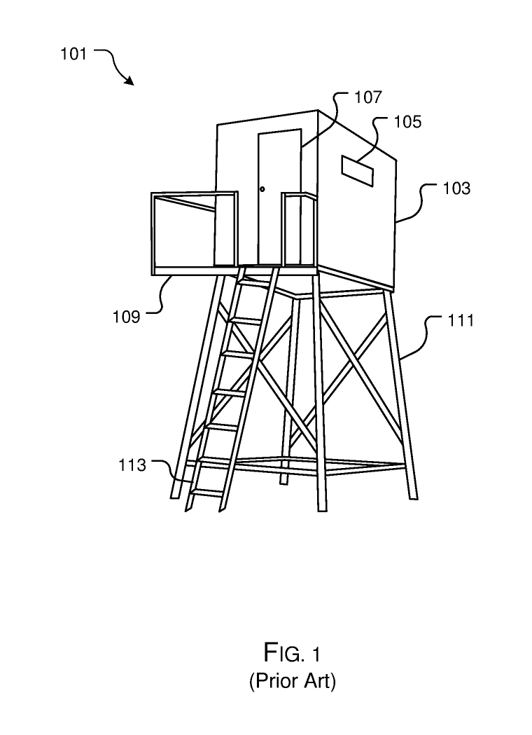

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional hunting blind systems. Specifically, the present invention provides an improved blind with sun blocking features and improved aerodynamic shape. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

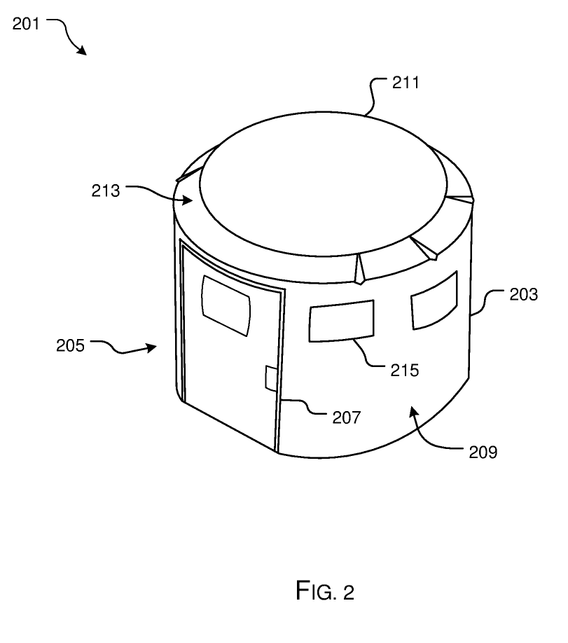

Referring now to the drawings wherein like reference characters identify corresponding or similar elements throughout the several views, FIG. 2 depicts an oblique view of a hunting blind system in accordance with a preferred embodiment of the present application. It will be appreciated that system 201 overcomes one or more of the above-listed problems commonly associated with conventional hunting blind systems.

In the contemplated embodiment, system 201 includes a rigid body 203 forming an interior area wherein a hunter can wait for a desired animal. In the preferred embodiment body 203 is substantially cylindrical and includes a front wall 205 with a door 207. Body 203 further includes an exterior surface 209 being composed of one or more materials configured to be camouflage, such colors can include browns, greens, blacks, and tans. System 201 further includes a rigid roof 211 secured to body 203 and having an exterior surface 213 of one or more camouflage colors. It should be appreciated that body 203 can further include a plurality of windows 215 to provide airflow through the interior area.

In the preferred embodiment, roof 211 and body 203, as well as a floor (not shown in FIG. 2) are manufactured as one piece, thereby eliminating any seams on the interior or exterior system 201. It should further be appreciated that the cylindrical shape and lack of seams creates an aerodynamic system, thereby being easily transported and capable of withstanding high winds. It should be appreciated that this is particularly important for a hunting blind system, as they are commonly elevated and exposed to substantial wind. The lack of seams and cylindrical shape protect the interior, reduce noise, and allow for airflow around the body. Further, it should be understood that the lack of seams helps to eliminate water leakage into the interior and helps to retain human scent within the interior, which is an important advantage when used for hunting.

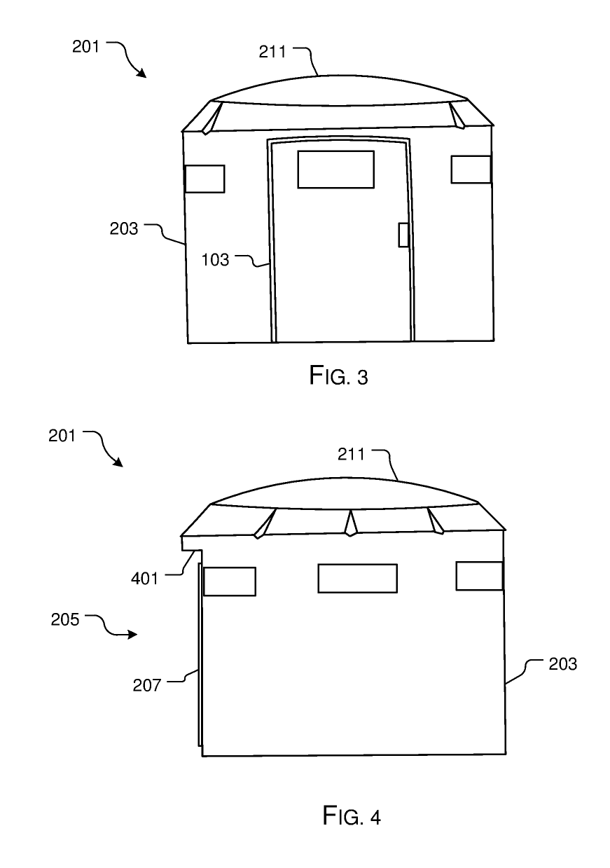

FIGS. 3 and 4 further show the features of system 201. In the preferred embodiment, roof 211 is dome shaped and extends over door 207 via a lip 401. In addition, in the preferred embodiment, the body and roof are substantially cylindrical, while front wall 205 is primarily flat.

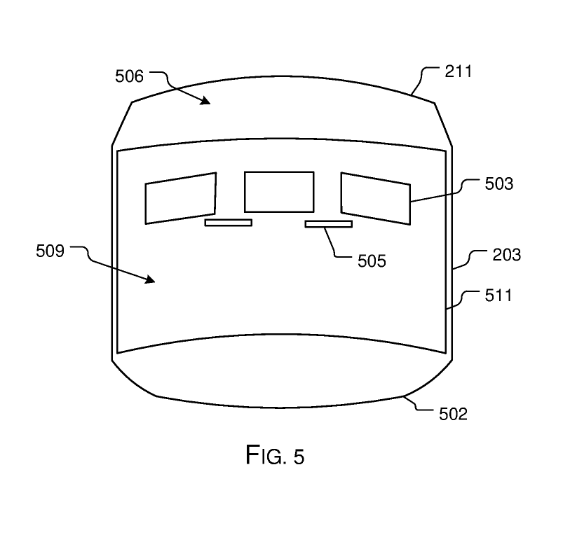

In FIG. 5, a partial interior view of system 201 is shown wherein no seam exists between the body, the roof 211, and a floor 502, wherein the interior area 501 provides access to one or more windows 503 and can include one or more shelves 505 or other various features such as cabinets, hooks, etc. In the preferred embodiment, roof 211 includes an interior surface 506 being composed of a sun blocking color, such as black. In addition, the body 203 includes an interior surface 509. In one embodiment, a noise absorbing material 511 is secured to surface 509, it should be appreciated that this material can be carpet, foam, padding, or any other noise reducing material. In other contemplated embodiments, surface 509 is composed of a sun blocking color.

It should be appreciated that one of the unique features believed characteristic of the present application is the use of a sun blocking color on the interior of the blind. It should be understood that this feature reduces the casting of shadows on the interior, thereby aiding in visibility for the user. Another unique feature believed characteristic of the present application is the manufacturing of the system as one seamless product.

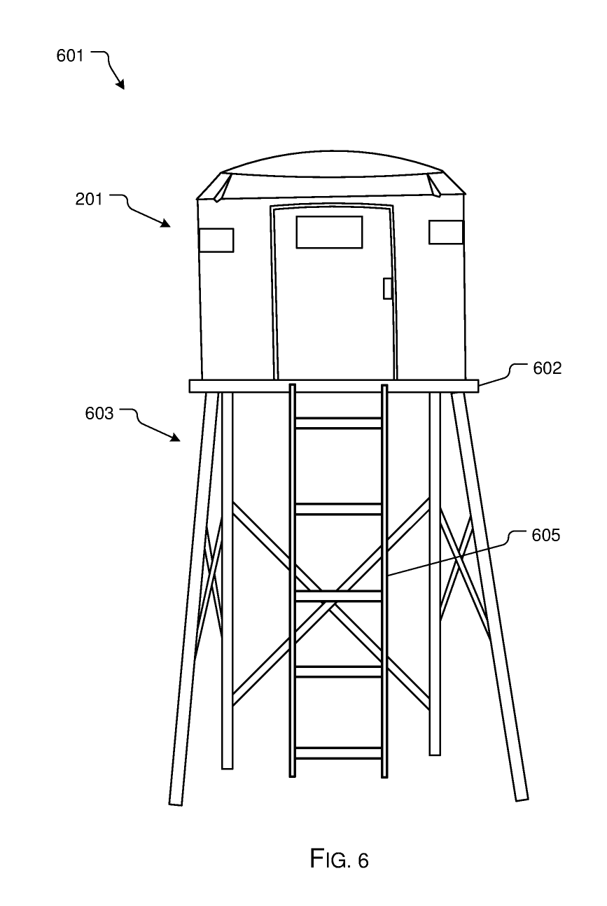

In FIG. 6, an alternative embodiment of a hunting blind system 601 is shown. In this embodiment system 201 is secured on a platform 602 associated with a stand 603, wherein a ladder 605 is positioned to provide access to system 201. It should be appreciated that in this embodiment, platform 602 and stand 603 can vary in height, size, and materials. In addition, it should be appreciated that ladder 605 could alternatively be a plurality of stairs or like structure configured to provide access.

It should be appreciated that the dimensions and materials of system 201 can vary as desired for aesthetical, functional, or manufacturing considerations.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A hunting blind system, comprising:
a rigid body forming an interior area, the rigid body having:
a front wall with a door positioned therein;
a rigid roof secured to a top of the rigid body, the rigid roof having:
an exterior surface having a first color; and
an interior surface facing the interior area and having a second color;
wherein the second color blocks sunlight.

2. The system of claim 1, wherein the rigid body further comprises:
a plurality of window frames configured to support a plurality of windows.

3. The system of claim 1, wherein the rigid body is primarily cylindrical and the front wall is substantially flat.

4. The system of claim 1, wherein the rigid roof is dome shaped.

5. The system of claim 1, further comprising:
a noise absorbent material secured to within the interior area of the body and to a plurality of interior area walls.

6. The system of claim 5, wherein the noise absorbent material is a carpeting.

7. The system of claim 1, further comprising:
one or more shelves integrally secured within the interior area.

8. The system of claim 1, wherein the roof extends over the door frame.

9. The system of claim 1, further comprising:
a stand having a platform configured to hold the rigid body and the rigid roof above a ground surface.

10. The system of claim 9, further comprising:
a ladder attached to the platform and extending to the ground surface.

11. The system of claim 1, wherein the second color is black.

12. The system of claim 1, wherein the rigid body and the rigid roof are integrally secured together, thereby having no seams.
